(19) United States
(12) Patent Application Publication
(10) Pub. No.: US 2010/0302632 A1
(43) Pub. Date: Dec. 2, 2010

(54) MICROSCOPIC SYSTEM

(76) Inventor: Herbert Luttenberger, Wein (AT)

Correspondence Address: Matthew J. Booth & Associates, PLLC;c/o CPA Global, P.O. Box 52050, 900 Second Avenue South, Suite 1560, Minneapolis, MN, 55402, US

(21) Appl. No.: 12/747,113

(22) PCT Filed: Dec. 10, 2008
(86) PCT No.: PCT/AT08/00441

§ 371 Date: Aug. 12, 2010

Related U.S. Application Data
(60) Provisional application No. 61/007,693, filed on Dec. 14, 2007.
(60) Provisional application No. 61/007,720, filed on Dec. 14, 2007.

(30) Foreign Application Priority Data
Dec. 10, 2007 (AT) A 1994/2007
Dec. 10, 2007 (AT) A 1995/2007

(51) Int. Cl. G02B 21/06; G02B 21/24

(52) U.S. Cl. 359/390

(57) ABSTRACT

The invention relates to a microscopic system for observing an object, comprising a lens and a work table (4), which has a work surface for placing the object to be observed thereon, wherein the work surface (50) is formed at least partially by a support plate (25) that is inserted in the work table (4), placed thereon, or connected thereto, and wherein the hardness of the material of which the support plate (25) is made is higher than that of glass, the support plate (25) being made of chemically hardened glass having a Vickers hardness greater than 610 HV, preferably a Vickers hardness in the range from 620 to 630 HV.

### CROSS REFERENCE TO RELATED APPLICATIONS

This application claims the benefits of the earlier filed Austrian Application Serial No. 1994/2007, filed 10 Dec. 2007, which is incorporated by reference for all purposes into this specification.

This application claims the benefits of the earlier filed Austrian Application Serial No. 1995/2007, filed 10 Dec. 2007, which is incorporated by reference for all purposes into this specification.

This application claims the benefits of the earlier filed U.S. Provisional Application Ser. No. 61007693, filed 14 Dec. 2007, which is incorporated by reference for all purposes into this specification.

This application claims the benefits of the earlier filed U.S. Provisional Application Ser. No. 61007720, filed 14 Dec. 2007, which is incorporated by reference for all purposes into this specification.

Additionally, this application is a 371 national stage application of PCT Patent App. Ser. No. PCT/AT2008/000441, filed 10 Dec. 2008, which is incorporated by reference for all purposes into this specification.

The present invention relates to a microscope system for observing an object, comprising a lens system and a work table which has a work surface onto which the object to be observed can be put, said work surface being at least partially formed by a supporting plate which is inserted into the work table, said supporting plate being formed of a material with a greater hardness than glass, and a lighting means being provided, said lighting means being coupled to said supporting plate in a way that at least part of said supporting plate emits light in order to illuminate the object put onto said supporting plate.

In order to improve the surface characteristics with a view to scratch resistance and resistance towards outside influences, modern microscope work tables are protected by means of surface coatings. In recent years, work tables with a ceramic-coated work surface (ceramic coated stage) have become widely spread, especially in the field of high-power microscopy. This type of surface protection is, however, not only technically complex and, thus, expensive, but also prone to signs of wear and tear after a short period of time, which leads to the partial disappearance of the coating and causes the work table to be unsightly. This limits the possible uses of the work table, as it is no longer resistant to corrosion, for example. Replacing the overall work table, however, entails high costs and re-ordering a work table takes a lot of time.

DE 195 41 233 A describes a microscope provided with a work table which has a transparent glass ceramic material at its top surface. The glass ceramic material used for this work table has a greater hardness than glass, which largely prevents the scratching of the surface. Such a glass ceramic plate has, however, not become widely used as a supporting surface for working tables, because its production is too complicated and it has to be quite thick in order to prevent it from breaking. This leads to the overall table being too heavy, and the desired smoothness of the X-Y movement cannot be achieved.

Attempts using other supporting surfaces did not lead to satisfying results with view to scratch and breaking resistance and easy replaceability.

US 2002/0008903 A1 shows an incident-light microscope in which the samples may be put onto a flat lighting means which is protected by hard glass and are held by a known clamp. The flat lighting means is used to directly illuminate the sample and not to light the background outside the light path.

The internet site “Chemisches Härten—Berliner Glas Technische Glaser” (XP-002519444) of 16 Mar. 2006 discloses a chemically strengthened glass with a high scratch resistance.

DE 10 2005 036397 A1 proposes the use of an OLED layer for transmittent illumination in a microscope.

The aim of the present invention consists in providing a microscope system of the type described at the beginning, the work table of which is protected against signs of wear and tear appearing during its use, and, at the same time, in keeping the production and maintenance costs low.

Another aim of the present invention consists in choosing an adequate material for a microscope work surface which fulfils the above-mentioned requirements.

A further aim of the invention consists in creating a microscope work surface which, on the one hand, may be easily cleaned and replaced, and, on the other hand, may be illuminated in a preferable way.

According to the invention, these aims are achieved by:
forming the supporting plate of a chemically strengthened glass which has a Vickers hardness of more than 610 HV and preferably a Vickers hardness in the range of 620 to 630 HV;
the work table, at the side facing the lens system, having a recess into which the supporting plate may be inserted, the supporting plate being inserted into the recess of the work table in a way that the supporting plate is positively engaged within the recess and may be taken out of the recess by being lifted;
forming the lighting means out of an electrically operated, active luminous film which is received within the work table, a light-emitting surface of the active luminous film being opposed to an area of the supporting plate, or out of an electrically operated substance which is disposed on at least certain areas of the supporting plate;
the supporting plate having a through-hole for transmitting light;
a recess into which said active luminous film is inserted being formed beneath the recess for the supporting plate in the work table;
the active luminous film or the applied luminous substance extending in the area next to the opening.

It has been shown that chemically strengthened glass in the hardness range according to the invention fulfils all the necessary requirements for a work supporting surface of a microscope work table and, at the same time, is scratch and mechanically resistant. The low production costs for the chemically strengthened glass of the supporting plate make it possible to implement said supporting plate in a way that it can be easily replaced by a new one.

According to the invention, the form of the supporting plate is not subject to any limitations, at least one surface onto which the object is put having to be adjusted to the respective object mounting or guiding device. If signs of wear and tear are found, the supporting plate can easily be lifted out of the work table and replaced by a new one. It is also possible to choose supporting plates which are adjusted to the respective application.

The supporting plate provided by the present invention can, thus, be easily replaced after a certain period of use, its surface characteristics, such as high scratch resistance, chemical resistance, flexibility, breaking resistance, and the like, fulfilling the requirements of a microscope work surface. It is essential that it is not one of the surfaces of the work table which has to be surface-treated, but that the separate supporting element may have the desired characteristics independently from the work table.

In order to make it possible to easily clean and replace the supporting plate, the supporting plate is inserted into the recess of the work table in a way that it is positively engaged within the recess and may easily be taken out of it by being lifted.

The lighting means is coupled to the supporting plate of the work table in a way that at least a part of the supporting plate emits light in order to illuminate the object put onto the supporting plate.

The user has the advantage of having an at least partially luminous, high-contrast work surface formed by the chemically strengthened supporting plate onto which the samples, object slides, or preparations may be put, while common work tables only provide a dark background without contrasts as a work surface. Pre-selection, marking, inspection, pre-definition, or the comparison with other objects are significantly facilitated and optimised, which makes it possible to work more rapidly and efficiently.

The thus obtained uniform and homogenous emission of light by an area of the supporting plate of the work table makes the illumination of the object and, thus, its pre-selection and localisation on a slide immediately next to the optical axis of the microscope system possible. The user may at first put the object which is to be observed onto the luminous work surface and, thanks to the resulting contrasts, look at it without any visual aids. As soon as the position of the object or the preparation on the slide has been determined, the slide may be moved into a position in which it is aligned with the optical axis of the microscope system of the invention and the object may then be observed through the microscopic system. This way the process of pre-selection can be significantly facilitated. The light-emitting part of the work surface provides a luminous area for a macrovisual inspection and an assessment of the objects in order to determine whether to use them for the microscopy process afterwards. It is possible, for example, to put several slides next to each other onto the luminous area of the work surface in order to pre-examine them and to compare them macroscopically in an efficient way.

The lighting means emits light as uniformly as possible throughout the respective area in order to make a uniformly strong illumination of the object possible, independently from its position on the surface. To achieve this aim, the lighting means may be formed by an electrically operated, active luminous film which is received in the work table, a light-emitting surface of the active luminous film being opposed to an area of the work surface in order to introduce the light produced by the luminous foil into the supporting plate and to make said supporting plate emit light.

This type of lighting source does not have a lighting filament and, thus, is robust when operated, because it is impact- and vibration-resistant.

Moreover, the active luminous film does not have a UV component, which is why it can be used in an eye- and object-protecting way. As no infrared light is emitted, there is no self-heating and, thus, no heating of the object put onto the work surface.

The lighting means according to the invention is formed within the work table in a way that it illuminates the objects put onto the supporting plate from below.

The supporting plate is inserted into a recess in the work table, and a lower-lying recess is formed in the work table into which the active luminous film is inserted. The lower-lying active luminous film is thus protected by the supporting plate against any mechanical loading.

The supporting plate may also only emit light in certain areas, if these areas are sufficiently large in order to place objects, for example on an object slide, in these areas and observe them beforehand without any visual aids.

In a preferred embodiment of the present invention the supporting plate has a Vickers hardness of 626 HV. This hardness has proved to lead to the best results with view to scratch resistance and mechanical strength.

Another exemplary embodiment of the invention may comprise a supporting plate with a bending strength of 150 N/mm². This value prevents the supporting plate from breaking too easily during handling.

It has proved advantageous for the supporting plate to have a ball impact resistance of 4 to 10 J in order to ensure the necessary robustness during use.

Below, the invention will be described referring to the exemplary embodiment shown in the figures wherein:

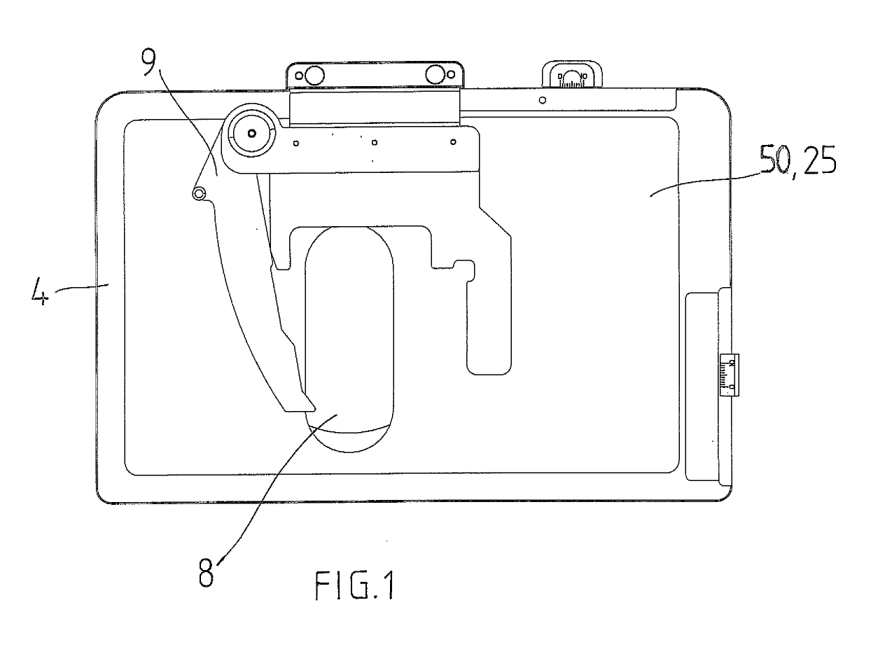

FIG. 1 shows a top view of an embodiment of the microscope system of the invention;

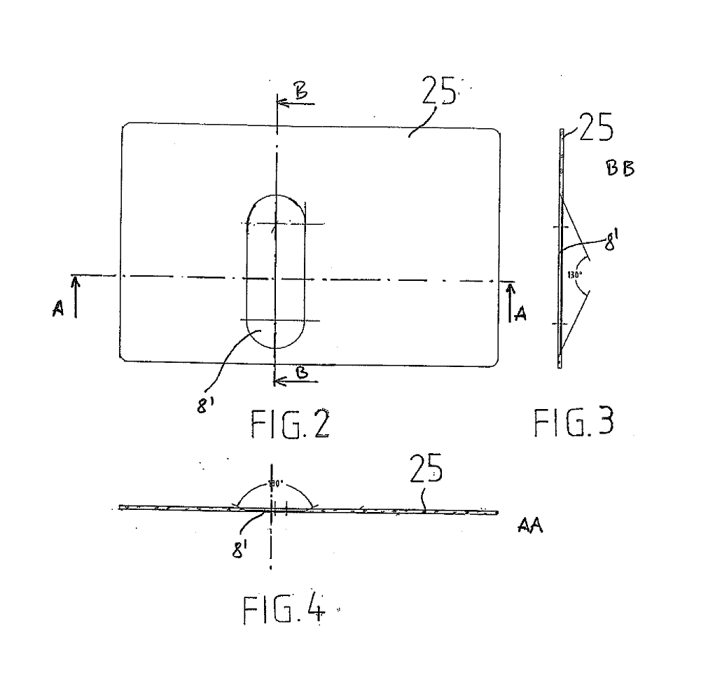

FIG. 2 shows a top view of a planar supporting element of the microscope system of the invention according to FIG. 1;

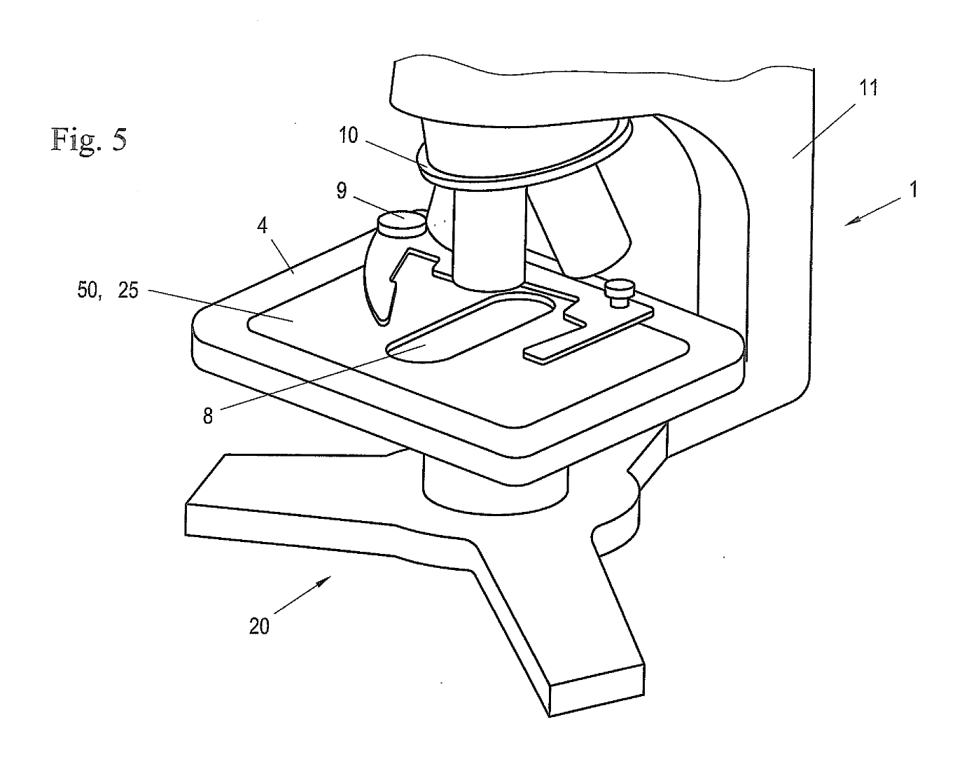

FIG. 3 shows a section BB through the planar supporting element according to FIG. 2;

FIG. 4 shows a section AA through the planar supporting element according to FIG. 2;

FIG. 5 shows a partial oblique view of the microscope system of the invention according to FIG. 1;

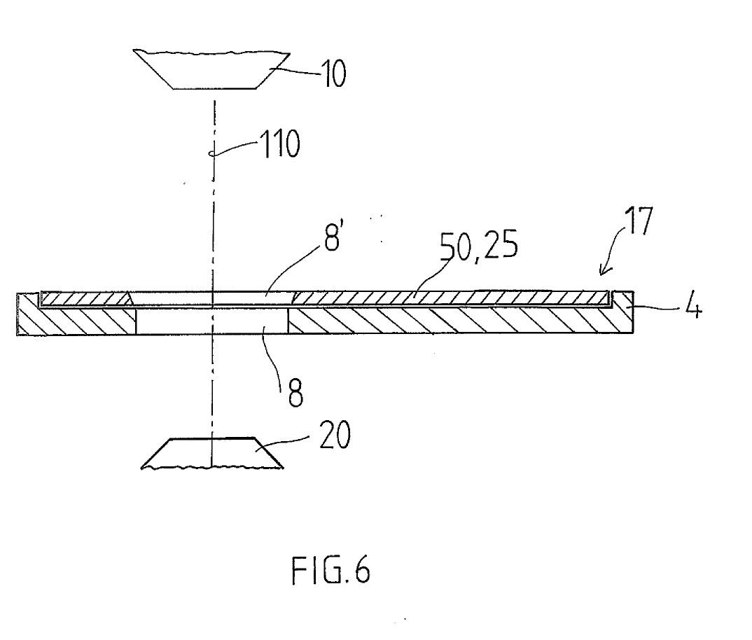

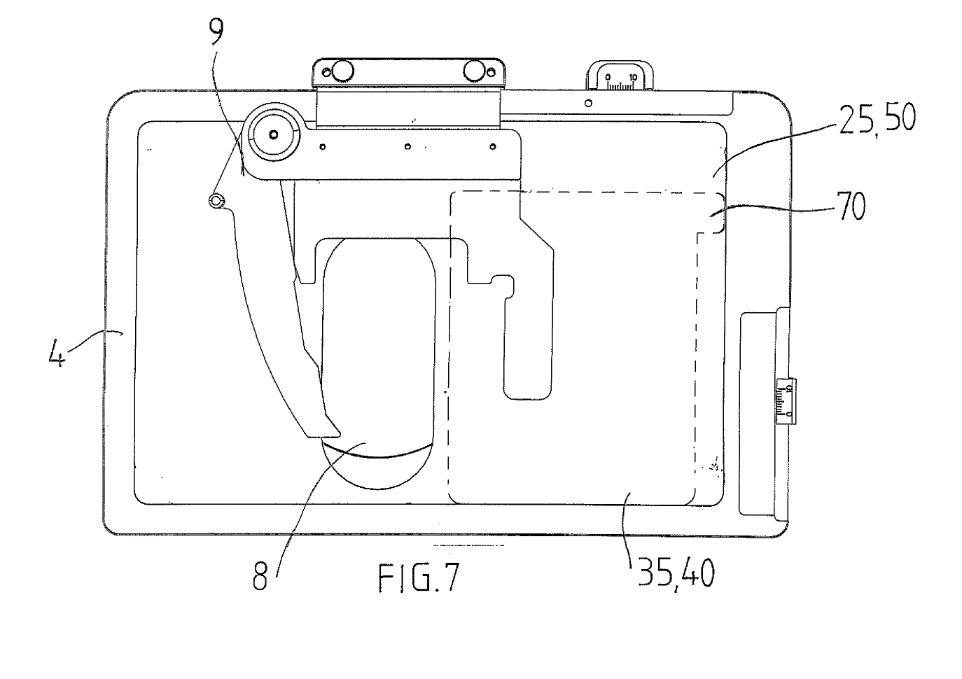

FIG. 6 shows a schematic cross-section through the work table of the microscope according to FIG. 1 and through the supporting element inserted therein;

FIG. 7 shows a top view of a work table according to another embodiment of the microscope system according to the invention;

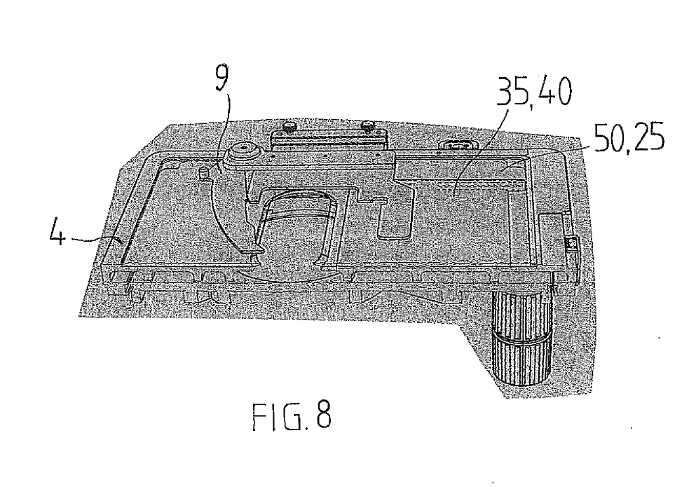

FIG. 8 shows a cross-section through a lateral oblique view of the microscope system according to FIG. 7;

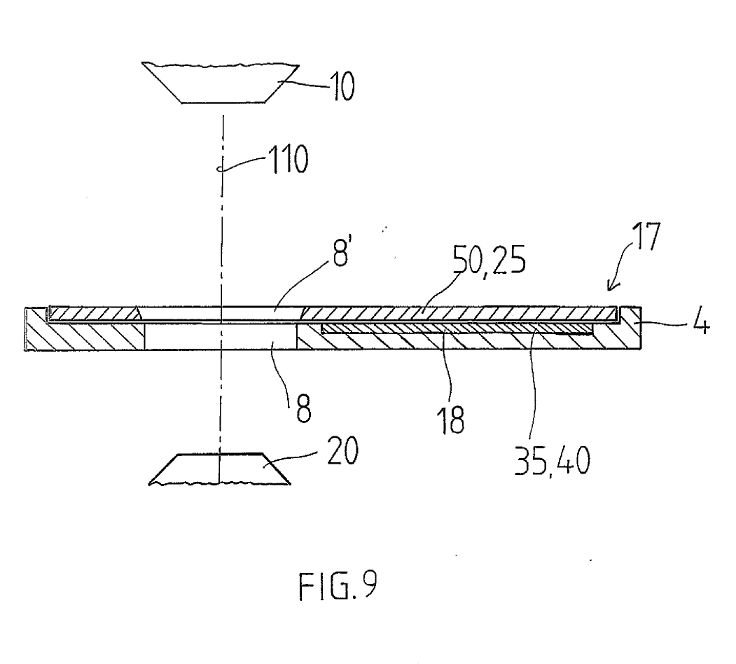

FIG. 9 shows a simplified schematic longitudinal section through the work table according to FIG. 8, and

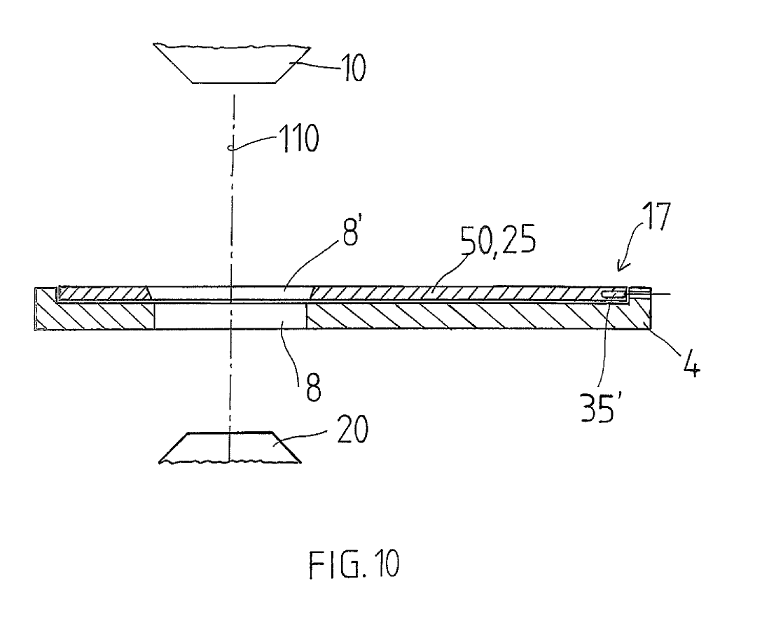

FIG. 10 shows a schematic longitudinal section through the work table according to another embodiment of the microscope system.

FIG. 5 shows a microscope system for observing an object which is not shown. In the example shown, a standard light microscope 1 is provided with a work table 4 for an operation with transmittent illumination. The invention may also be applied to other microscope systems which are known to those skilled in the art.

Lenses 10 as parts of a lens system are supported by a stand 11. In the course of the optical axis 110 (FIG. 6) of the standard light microscope 1, a condenser 20 through which light enters into one of the lenses 10 through an elongated hole 8 (FIG. 1) in the work table 4 is located beneath the work table 4. The elongated hole 8 makes it possible to move the work table 4 within its plane along the main axis of the elongated hole without impeding the light rays due to mechanics. The embodiment of the lens system may vary depending on the respective application, but does not limit the scope of application of the present invention in any way. By means of an X-Y object guide 9 (FIG. 1), objects, such as preparations, may be held on an object slide and may be moved on the work table 4.

The work table 4 has a work surface 50 onto which the object to be observed is put. The work surface 50 is formed by a supporting plate 25 which is inserted into the work table 4. The supporting plate could also be put onto the work table 4 or could be coupled to it by means of a screw connection, for example. As the supporting plate 25 is formed separately, it may easily be replaced and adapted to the respective requirements. The supporting plate 25 is not part of the work table 4.

According to the invention, the supporting plate 25 consists of chemically strengthened glass with a Vickers hardness of more than 610 HV, preferably with a Vickers hardness in the range from 620 to 630 HV. In the following table 1, the characteristics of an exemplary supporting plate 25 according to the invention are listed and compared to untreated glass.

TABLE 1
Characteristics of chemically strengthened glass compared to untreated glass.

| | Chemically strengthened glass | Untreated glass |
|---|---|---|
| Impact resistance | 4 to 10 J (depending on the | 1 to 2 J (1 joule = 1 N*m) |
| (tested using a ball) | testing conditions) | |
| Bending strength σ bB: | 150 N/mm² | 50 N/mm² |
| (according to EN 12337) | | |
| Resistance to temperature | 350° C. for 1-mm-thick glass | 170° C. for 1-mm-thick glass |
| changes acc. to DIN 52313 | 300° C. for 2-mm-thick glass | 130° C. for 2-mm-thick glass |
| | 270° C. for 3-mm-thick glass | 120° C. for 3-mm-thick glass |
| | 250° C. for 4-mm-thick glass | 100° C. for 4-mm-thick glass |
| Vickers hardness | 626 HV 0.2/1 5 | 550 HV 0.2/15 |
| Operation temperature | 300° C.* | 450° C. |

More preferably, the supporting plate 25 has a Vickers hardness of 626 HV.

Moreover, the supporting plate 25 has a bending strength in the range from 130 to 170 N/mm², preferably of 150 N/mm².

Another characteristic of the supporting plate 25 consists in a ball impact resistance in the range from 4 to 10 J.

The thickness of the supporting plate 25 is selected to amount to 1.3 mm+/−0.1 mm, for example, lying in the preferable range from 1.2 mm to 1.5 mm which provides sufficient strength and scratch resistance to the supporting plate 25, but, at the same time, makes it flexible in order to prevent it from breaking when being replaced or under strain. Due to its relatively small thickness, the supporting plate 25 may be inserted into common work tables. The work table does not have to be reinforced.

According to FIG. 1, the supporting plate 25 is formed by a rectangular, plane-parallel plate made of strengthened glass with rounded corner areas which is transparent or at least partly transparent. The supporting plate 25 which is used is shown without the work table 4 in the FIGS. 2, 3, and 4.

The supporting plate 25 may have different sizes for different microscope types, and after having been put under extreme strains and when showing signs of wear and tear, it is replaced by a new one or cleaned.

Moreover, the supporting plate 25 may have different characteristics. It may, for example, have an etched surface on one side.

For safety reasons, the supporting plate 25 may consist of safety glass having a safety film on one side which holds the splinters together in case the glass breaks.

On the side facing the lens system, the work table 4 has a recess 17 (FIG. 6) into which the supporting plate 25 may be inserted. Said supporting plate 25 is inserted into the recess 17 of the work table 4 fittingly so that it is held within the recess 17 by means of positive engagement, i.e. without requiring any force, and may be taken out of the recess by simply lifting it. By adequately selecting the manufacturing tolerances, it is made sure that the supporting plate 25 remains in the recess 17 when the microscope is in use. The supporting plate 25 may be taken out of the recess 17 without loosening screws or any other type of connection, and may then, for example, be cleaned or replaced. This does not require any great efforts, the user putting a finger into the elongated hole 8 in order to remove the supporting plate 25 from the recess 17, and is, thus, not conceived as troublesome.

In the case of an inverted embodiment of the optical system of the invention, the lens system 10 would be located on the bottom side and the condenser 20 would be located on the top surface of the work table 4. Accordingly, the recess 17 would be provided on the side of the work table 4 which is averted from the lens system 10.

Depending on the location of the elongated hole 8 in the work table, a through-hole 8′ is provided in the supporting plate 25 for the penetration of light.

In the embodiment according to the FIGS. 7 and 8, a lighting means 35 which is coupled to the work surface 50 of the work table 4 in such a way that at least a part of the work surface 50 emits light in order to illuminate the object put onto the work surface 50 is provided.

The lighting means 35 makes a pre-selection of the object possible and is formed by an electrically operated, active luminous film 40 which is received in the work table 4, a light-emitting surface of the active luminous film 40 being opposed to an area of the work surface 50 (FIG. 9). For the active luminous film 40, a luminous medium, such as zinc sulfate, is disposed on a metallised, transparent polyester film and an insulating layer and a back electrode are printed onto it. By means of a lateral contact zone 70, the film is coupled to a voltage source (not shown) which is necessary for its operation. The luminous film 40 may be insulated by an adequate laminate.

The active luminous film 40 is inserted into a lower-lying recess 18 formed in the work table 4 (FIG. 9).

FIG. 9 shows that the supporting plate 25 has a through-hole 8′ for letting light penetrate to reach the lens system of the microscope, the active luminous film 40 extending in the area next to the through hole 8′.

The separate active luminous film 40 may also be replaced by an active luminous layer applied to the supporting plate 25, preferably by printing, which may also be electrically operated. Other lighting means which may be used are known to those skilled in the art and may be used for applications of the invention.

FIG. 10 shows an embodiment in which the lighting means is formed by one or more LEDs 35′, the LED(s) 35′ being embedded into a front side of the work surface 50 which is formed by the supporting plate 25. The LED terminals are guided outwards through a bore at the side of the table 4.

By introducing light at the front side, the supporting plate 25 emits light in the direction of the lens system 10 and serves to illuminate the object from below.

1-15. (canceled)

16. A microscope system for observing an object, comprising:
a lens system and a work table (4) having a work surface (50) onto which the object to be observed is put, said work surface (50) being formed at least partially by a supporting plate (25) which is inserted into said work table (4), the material of which said supporting plate (25) is formed having a higher hardness than glass, and a lighting means (35, 35′) being provided, said lighting means (35, 35′) being coupled to said supporting plate (25) in a way that at least a part of said supporting plate (25) emits light in order to illuminate the object put onto said supporting plate (25);
wherein:
said supporting plate (25) consists of chemically strengthened glass with a Vickers hardness of more than 610 HV, preferably with a Vickers hardness in the range from 620 to 630 HV;
said work table (4) has a recess (17) into which said supporting plate (25) may be inserted on the side facing the lens system, said supporting plate (25) being inserted into said recess (17) of the work table (4) in a way that said supporting plate (25) is positively engaged within the recess (17) and may be taken out of said recess by simply lifting it;
said lighting means (35, 35′) is formed by an electrically operated, active luminous film (40) which is received in the work table (4), a light-emitting surface of said luminous film (40) being opposed to an area of said supporting plate (25), or by an electrically operated substance which is disposed at least in some areas of said supporting plate;
said supporting plate (25) has a through-hole (8′) for the penetration of light,
a recess (18) into which said active luminous film (40) is inserted is formed in the work table (4) below said recess (17) for said supporting plate (25);
and in that said active luminous film (40) extends in the area next to the through hole (8′).

17. The microscope system according to claim 1, wherein said supporting plate (25) has a Vickers hardness of 626 HV.

18. The microscope system according to claim 1, wherein said supporting plate (25) has a bending strength of 150 N/mm2.

19. The microscope system according to claim 1, wherein said supporting plate (25) has a ball impact resistance from 4 to 10 J.

20. The microscope system according to claim 1, wherein said supporting plate (25) is rectangular.

21. The microscope system according to claim 1, wherein the substance which is disposed on said supporting plate (25) is printed onto it.

22. The method to manufacture a microscope system for observing an object, comprising:
providing a lens system and a work table (4) having a work surface (50) onto which the object to be observed is put, said work surface (50) being formed at least partially by a supporting plate (25) which is inserted into said work table (4), the material of which said supporting plate (25) is formed having a higher hardness than glass, and a lighting means (35, 35′) being provided, said lighting means (35, 35′) being coupled to said supporting plate (25) in a way that at least a part of said supporting plate (25) emits light in order to illuminate the object put onto said supporting plate (25);
wherein:
said supporting plate (25) consists of chemically strengthened glass with a Vickers hardness of more than 610 HV, preferably with a Vickers hardness in the range from 620 to 630 HV;
said work table (4) has a recess (17) into which said supporting plate (25) may be inserted on the side facing the lens system, said supporting plate (25) being inserted into said recess (17) of the work table (4) in a way that said supporting plate (25) is positively engaged within the recess (17) and may be taken out of said recess by simply lifting it;
said lighting means (35, 35′) is formed by an electrically operated, active luminous film (40) which is received in the work table (4), a light-emitting surface of said luminous film (40) being opposed to an area of said supporting plate (25), or by an electrically operated substance which is disposed at least in some areas of said supporting plate;
said supporting plate (25) has a through-hole (8′) for the penetration of light,
a recess (18) into which said active luminous film (40) is inserted is formed in the work table (4) below said recess (17) for said supporting plate (25);
and in that said active luminous film (40) extends in the area next to the through hole (8′).

23. The method according to claim 22, wherein said supporting plate (25) has a Vickers hardness of 626 HV.

24. The method according to claim 22, wherein said supporting plate (25) has a bending strength of 150 N/mm2.

25. The method according to claim 22, wherein said supporting plate (25) has a ball impact resistance from 4 to 10 J.

26. The method according to claim 22, wherein said supporting plate (25) is rectangular.

27. The method according to claim 22, wherein the substance which is disposed on said supporting plate (25) is printed onto it.
